(19) United States
(12) Patent Application Publication
(10) Pub. No.: US 2019/0326032 A1
(43) Pub. Date: Oct. 24, 2019

(54) ELECTRICALLY INSULATING MATERIAL, ELECTRICALLY INSULATING COATING COMPOUND AND ELECTRICALLY INSULATED WIRE MADE FROM STILBENE SERIES POLYESTERIMIDE

(71) Applicant: TOTOKU TORYO CO., LTD., Tokyo (JP)

(72) Inventors: Toshimi KOGA, Honjo City (JP); Yuichi FUJIKURA, Honjo City (JP); Takatoshi WATANABE, Honjo City (JP); Shih JUNG-SHUN, Tokyo (JP)

(73) Assignee: TOTOKU TORYO CO., LTD, Tokyo (JP)

(21) Appl. No.: 16/366,472

(22) Filed: Mar. 27, 2019

(30) Foreign Application Priority Data
Mar. 28, 2018 (JP) 2018-062432

(51) Int. Cl. H01B 3/30; H01B 7/29; C08G 73/16; C08K 3/38; C08K 3/34; C08K 3/28; C08K 3/22

(52) U.S. Cl. CPC H01B 3/306; H01B 7/292; C08G 73/16; H02K 3/30; C08K 3/34; C08K 3/28; C08K 3/22; C08K 3/38

(57) ABSTRACT

An electric insulating material, an electric insulating coating compound used this material and an electric insulating wire used this coating compound having excellent thermal conduction performance (high thermal conductivity), said material, coating compound and wire comprised of a polyesterimide resin having repeating unit of 4,4′-Stilbenedicarbonate group, specifically, wherein the polyesterimide resin comprised of ester bond of stilbenedicarboxylic acid. Said resin is useful for insulated coils of electric motors of solar car used solar batteries, and it is particularly excellent in thermal conduction performance, also excellent in heat resistance and the like, thermal conduction performance can be improved without using a filler.

### TECHNICAL FIELD

The present invention relates to an electric insulating material, an electric insulating coating compound used this material and an electric insulating wire used this coating compound having excellent thermal conduction performance (high thermal conductivity), for further details, the present invention relates to the electric insulating material, the electric insulating coating compound used this material and the electric insulating wire used this coating compound having excellent thermal conduction performance (high thermal conductivity) comprised of a polyesterimide resin having a repeating unit of 4,4′-Stilbenedicarbonate group, specifically, the polyesterimide resin having an ester bond of a stilbenedicarboxylic acid.

### TECHNICAL BACKGROUND

A solar car of an automobile has a solar battery as an electric power supply, and the solar car of the automobile can be drove by the an electric motor.

In the solar car, an energy of a light from the sun changes into the electric energy, it's power takes from said electric energy, and said electric energy feeds to an electric motor, then, the solar car can be drove by a tire turns over.

The electric motor of the solar car needs that it is lightweight and high-efficiency in order to make best use of the electric power of the solar battery.

The electric motor is an electrical equipment which the electric energy changes into a mechanical energy. The electric motor comprising a rotor, a stator which ingenerates a torque by interaction between the rotor, a rotary shaft which can transmit the revolution of the rotor for external, a bearing which can be support the rotary shaft and a cooling device which can cool off about the heat produced by dissipation.

There are many kinds in the electric motor, there is the electric motor which the insulating coil winds in the stator and a varying magnetic field ingenerates by feeding of changing electric current to said coil, said coil needs excellent performance of thermal conduction namely having excellent thermal conduction performance (having high thermal conductivity) in order to give out heat by using thereof.

In order to enhance said thermal conduction performance (thermal conductivity) of an electric equipment, the metal oxide and the thermally conductivity filler, for example, zinc oxide, beryllium oxide, zinc aluminum, aluminum nitride, nitriding boron, silicon oxide, aluminum powder, carbon black, micronized silica, bentonite, diamond were used in the past (Japan Unexamined Patent Publication No. 2004-91743, Japan Unexamined Patent Publication No. 2008-25538). Said filler, as a figure of the electric insulating coating compound (varnish), for example, as one figure, the insulating coating compound comprised of styrene block copolymerization, tacky adhesion grant resin and solvent was used, wherein the insulating coating compound included the fillers, for example, the insulating coating compound included nitriding boron (BN), silicon carbide (SiC), aluminum nitride (ALN), aluminum oxide (Al₂O₃), silicon nitride (SiN), silicon oxide (SiO₂), magnesium oxide (MgO), zinc oxide (ZnO), or titanium oxide (TiO₂) was offered (Japan Unexamined Patent Publication No. 2008-174697, Japan Unexamined Patent Publication No. 2008-303263, Japan Unexamined Patent Publication No. 2008-026699).

However, on the other hand, when using of said filler, said filler muddy to the electric insulating coating compound, then, nevertheless said filler does not use, there was request for possibility of enhance of thermal conduction performance (thermal conductivity) by a constituent resin of the electric insulating coating compound.

Polyesterimide resin is used for electrically insulating coating compound and electrically insulated electric wire. With respect to the polyesterimide resin, in addition to providing heat resistance and the like, addition of the thermal conductivity, it becomes a problem.

With respect to the polyesterimide resin, there are various polyesterimide resins, and polyesterimide resins using stilbene dicarboxylic acid or a chloride or amide thereof as an aromatic dicarboxylic acid as a raw material thereof are also available.

Japan Unexamined Patent Publication No. 2008-101124 discloses an aromatic polycarboxylic acid derivative which reacts with an isocyanate component or an amine component to form a polyimide-based resin and contains 3,3′,4,4′-diphenylsulfonetetracarboxylic acid di-anhydride is exemplified, it is disclosed that the polyimide type tree has electrical insulating properties and is used for a polyimide type resin varnish, however, there is no disclosure on polyesterimide. Japan Unexamined Patent Publication No. 2010-224319 discloses a photosensitive composition containing a binder, a polymerizable compound and a photopolymerization initiation, wherein the binder contains an acid-modified polyesterimide resin, wherein the acid-modified polyesterimide resin is obtained through a step of obtaining an imide resin by reacting an imide group-containing dicarboxylic acid with a diglycidyl ether type epoxy resin and a step of adding an acid anhydride to at least a part of hydroxyl groups in the polyesterimide resin, and the imide group-containing dicarboxylic acid is obtained by reacting a tricarboxylic acid anhydride or a dicarboxylic acid and diisocyanate diamine.

However, maleic acid and the like are merely exemplified as the dicarboxylic acid, and there is no description about stilbene dicarboxylic acid.

Japan Unexamined Patent Publication No. 2006-199855 describes an optical compensation film in which an optically anisotropic layer is laminated on a polymer film, and that the optically anisotropic layer contains a polymer film, polyesterimide (for example, Japan Unexamined Patent Publication No. 64-38472) is described as one of polymers in the film.

In Japanese Translation of PCT International Application Publication No. JP-T-No. 09-50-6911, a polyesterimide for use in linear and/or nonlinear optics is described, and is described that said polyesterimide is a polyesterimide comprising a repeating ester function, a repeating imide function and a chromophore.

Japan Unexamined Patent Publication No. 2017-110184 describes a method for manufacturing a coating film for a wire used for a motor and an alternator, and describes that the coating film has a film thickness of even though it is thin, it is excellent in electrical insulation, conductor adhesion, heat resistance, not only applied to parts such as motors, alternators, transformers, but also applied to a coating film of enamel windings, in order to have features thin film and high insulation. Also, describes that this coating film for a winding can be obtained by adding nanoparticles to a heat-resistant resin solusion such as polyesterimide and dispersing at high speed.

Japanese Unexamined Patent Publication No. 2014-225433 describes an insulated wire including a conductor and an insulating layer laminated on the outer peripheral side of the conductor, and the insulated electric wire has a primer layer between the conductor and the insulating layer. Also, describes the primer layer is made of polyesterimide, the primer layer is a layer which enhances the adhesion between the insulating layer and the Conductor and can effectively improve properties such as flexibility and abrasion resistance, scratch resistance, and workability of the insulated electric wire.

In this Publication No. 2014-225433 describes the polyesterimide is a resin having an ester bond and an imide bond in its molecule, for example, by reacting an imidodicarboxylic acid which is a reaction product of a tricarboxylic anhydride and a diamine with a polyhydric alcohol can be obtained.

However, there is no description about the polyesterimide resin using stilbenedicarboxylic acids as aromatic dicarboxylic acid.

Japanese Unexamined Patent Publication No. 2017-095627 describes a polyesterimide coating material using the polyesterimide resin excellent in adhesion to a conductor and heat resistance deterioration resistance, and an insulated wire and a coil formed by using the polyesterimide coating material.

The polyesterimide resin (A) comprising a diamine component (a1), an acid component (a2) and an alcohol component (a3) as a component, a polyhydric alcohol (B) as an adhesion improver, an organic solvent (C), which is a polyesterimide coating compound.

As the acid component (a2), an acid anhydride can be used.

As the acid anhydride, aromatic tetracarboxylic acid dianhydride such as trimellitic anhydride and the like are mentioned, and trimellitic anhydride is particularly preferable.

Further, as the acid component (a2), there is a description that a dicarboxylic acid may be used together with an acid anhydride, but there is no description about a polyesterimide resin using a stilbenedicarboxylic acid as a dicarboxylic acid.

Japanese Unexamined Patent Publication No. 2014-205828 describes a polyesterimide resin film having both excellent heat resistance, flexibility, and low hygroscopicity, as well as resins and resin compositions used therein.

Also, this case describes that tricarboxylic acid anhydride, tetracarboxylic anhydride, dicarboxylic acid and the like can also be used as the acid component used for producing the polyesterimide resin.

But, there is no description about polyesterimide resin using stilbenedicarboxylic acids as aromatic dicarboxylic acid.

Japanese Unexamined Patent Publication No. 2014-049230 describes an insulated wire and a coil using the insulated wire, wherein the insulated wire comprises a conductor and a base resin formed in close contact with the outer periphery of the conductor. As a polyesterimide as the base resin, polyimide obtained from an acid component composed of an aromatic tetracarboxylic acid dianhydride and a diamine component comprising an aromatic diamine can be cited.

In addition, as a polyesterimide used for a base resin, there is a description that polyesterimide obtained from an acid component such as a diamine component and a tricarboxylic acid anhydride and an alcohol component can be cited.

However, there is no description about polyesterimide resin using stilbenedicarboxylic acids as the aromatic dicarboxylic acid as the acid component.

Published Japanese Translation of PCT International Application No. 2008-542506 describes a copolyester.

A unit consisting of the following a), b) and c):

a) about 1 to 40 mol % trans-3,3-stilbenedicarboxylic acid, trans-4,4-stilbenedicarboxylic acid, and combinations thereof,
b) about 99 to 60 mol % cis-1,4-cyclohexanedicarboxylic acid, trans-1,4-cyclohexanedicarboxylic acid, and combinations thereof,
c) about 50 to 100 mol % cis-1,4-cyclohexanedimethanol, trans-1,4-cyclohexanedimethanol, and combinations thereof.

There is a description that the obtained copolyester has the feature that the thermal properties are improved by the presence of the stilbene portion and that the copolyester has transparency.

U.S. Pat. No. 5,811,507 describes a polyesterimide including a repeating ester functional group, a repeating imide functional group and a chromophore, but this case relates to the optical, don't describe about stilbene dicarbonate and stilbene.

U.S. Pat. No. 9,871,225 describes stilbene, but this case is for organic electroluminescent devices.

U.S. Pat. No. 9,871,220 describes a color material based on stilbene, but this case relates to a transparent electrode and an electronic device.

U.S. Pat. No. 9,871,201 describes stilbene, but this case relates to electrodes.

U.S. Pat. No. 9,868,876 describes stilbene, but this case relates to silicone type coating compound.

U.S. Pat. No. 9,868,803 describes stilben, but this case relates to display.

U.S. Pat. No. 9,859,502 describes stilben, but this case relates to display.

U.S. Pat. No. 9,860,960 describes stilbene as a low molecular weight material, but this case relates to electrodes.

As described above, the insulated coil made of the electrically insulated electric wire of the electrical equipment is required to have good thermal conductivity, but in the case of the motor, reactor (inductance), etc. in the solar cell described above, it is necessary to have excellent heat resistance (heat softening temperature) even at high temperatures, from the viewpoints of high voltage by high current and the like, and self-fusion work by heating is carried out at high temperature and the like, heat shock resistance and the like, and furthermore, heat shock resistance and the like are also required in order to prevent a decrease in the service life of the electrical equipment and the like.

### [Patent Documents 1]:

Japan examined Patent Publication No. Showa 52-33272,
Japan Unexamined Patent Publication No. Hei. 10-110179,
Japan Unexamined Patent Publication No. 2004-91743,
Japan Unexamined Patent Publication No. 2008-25538,
Japan Unexamined Patent Publication No. 2008-174697,
Japan Unexamined Patent Publication No. 2008-303263,
Japan Unexamined Patent Publication No. 2008-026699,
Japan Unexamined Patent Publication No. 2008-101124,
Japan Unexamined Patent Publication No. 2010-224319,
Japan Unexamined Patent Publication No. 2006-199855,
Japan Unexamined Patent Publication No. 64-38472,
Japanese Translation of PCT International Application Publication No. JP-T-No. 09-50-6911,
Japan Unexamined Patent Publication No. 2017-110184,
Japanese Unexamined Patent Publication No. 2014-225433,
Japanese Unexamined Patent Publication No. 2017-095627,
Japanese Unexamined Patent Publication No. 2014-205828,
Japanese Unexamined Patent Publication No. 2014-049230,
Published Japanese Translation of PCT International Application No. 2008-542506,
U.S. Pat. No. 5,811,507,
U.S. Pat. No. 9,871,220,
U.S. Pat. No. 9,871,201,
U.S. Pat. No. 9,868,876,
U.S. Pat. No. 9,868,803,
U.S. Pat. No. 9,859,502,
U.S. Pat. No. 9,860,960,

### DISCLOSURE OF INVENTION

### Problems to be Solved by the Invention

It is therefore an object of the present invention to provide technical skill to eliminate the above-mentioned problems, and to provide technical skill can be reply the above-mentioned request. In particular, the present invention aims to impart further excellent thermal conduction performance (high thermal conductivity) to the polyesterimide resin which is excellent as an electrically insulating material having excellent heat resistance, and the like.

The foregoing and other objects and novel features of the present invention will become clear from the following description and the accompanying drawings.

### Means for Solving the Problems

The inventors of the present invention have found a resin constituting an electrically insulating material capable of improving thermal conduction performance (thermal conductivity) even when a filler is not used, particularly about the polyesterimide resin having excellent heat resistance and excellent electrical insulating performance, the present inventors have found that a resin having a repeating unit of 4,4′-stilbenedicarbonate is excellent in thermal conductivity, particularly, the present inventors have found that the polyesterimide resin having a repeating unit of an ester bond of 4,4′-stilbene dicarboxylic acid and a repeating unit of an imide bond of a tetracarboxylic anhydride has excellent thermal conductivity and make clear the above objects.

That is, the present invention relates to the following matter.

1. An electric insulating material having excellent thermal conduction performance (high thermal conductivity) inclusing the polyesterimide resin having the repeating unit of 4,4′-Stilbenedicarbonate group.

2. The electric insulating material having excellent thermal conduction performance (high thermal conductivity) according to above item 1, wherein the polyesterimide resin is the polyesterimide resin having a repeating unit of 4,4′-stilbenedicarbonate expressed by a following general formula (1), and having a repeating unit of an imide bond of a tetracarboxylic acid by a following general formula (2)

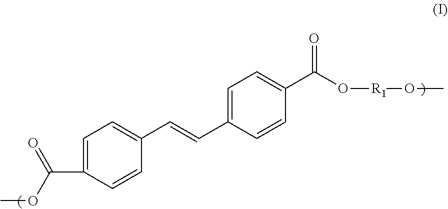

In the general formula (I), R₁ is alcohol residue.

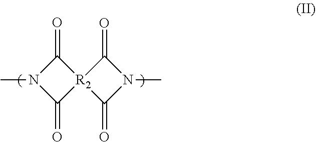

In the general formula (II), R₂ is a tetracarboxylic acid residue.

3. The electric insulating material according to above item I or 2, further comprising the polyesterimide resin added a ceramic powder.

4. The electric insulating material according to above item (3), wherein the ceramic powder selected from group consisting of boron nitride, silicon carbide, aluminum nitride and aluminum oxide.

5. An electric insulating coating compound including at least one of the electric insulating materials of above item (1) to (4).

6. An electric insulating wire comprising the electric insulating coating compound of above item 5 and a conductor, wherein the electric insulating wire made by coating and baking of said electric insulating coating compound on the conductor.

### Effects of the Invention

According to the present invention, there are the following advantages. According to the present invention, as described in above item (1), when said polyesterimide resin comprised of the polyesterimide resin having the repeating unit of 4,4′-Stilbenedicarbonate group, the electric insulating material included said polyesterimide resin can be obtained excellent thermal conduction performance (high thermal conductivity) and the above object can be achieved.

According to the present invention, as described in the above 2, as the polyesterimide resin having the repeating unit of the 4,4′-stilbenedicarbonate group according to the above 1, with the polyesterimide resin having repeating of ester linkage of 4,4′-stilbenedicarboxy group represented by formula (I),

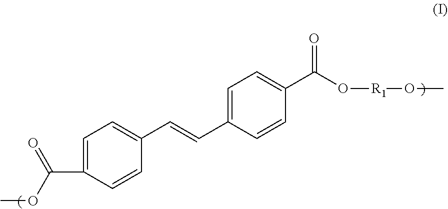

in the general formula (1), R₁ is alcohol residue,
and having the imide bond repeating unit of an aromatic tetracarboxylic acid represented by the following general formula (II),

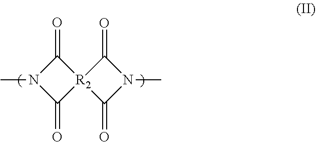

in the general formula (II), R₂ is a tetracarboxylic acid residue,
it can be made into an excellent electrically insulating material which is more excellent in thermal conductivity and can achieve the above object.

According to the present invention, as described in the above 3, addition of the ceramic powder to the polyesterimide resin makes it possible to further improve thermal conductivity and exert excellent operational effects.

According to the present invention, as described in 4 above, the ceramic powder is one or more selected from the group consisting of boron nitride, silicon carbide, aluminum nitride, and aluminum oxide, it is possible to further improve thermal conductivity and exert excellent operational effects.

According to the present invention, as described in the above item 5, if an electrically insulating coating material containing any one of the electrically insulating materials described above in 1-4 is used, it is not only excellent in thermal conductivity, but also excellent in heat resistance and the like.

According to the present invention, as described in the above 6, by forming an electrically insulated electric wire by coating and baking the electric insulating coating material on a conductor, it may be obtain the electrically insulated wire having excellent in thermal conductivity and in heat resistance and the like.

### BEST MODE FOR CARRYING OUT THE INVENTION

In the polyesterimide resin of the present invention, it may be obtained by reacting with the following (A), (B), (C) and (D) component,

4,4′-stilbene dicarboxylic acid or a derivative thereof (A),
an alcohol component (B) capable of reacting with the 4,4′-stilbene dicarboxylic acid or a derivative thereof to form an ester bond,
an acid component (C) excluding 4,4′-stilbene dicarboxylic acid or a derivative thereof, and a diamine component (D) which reacts with the acid component (C) to form an imide bond.

In 4,4′-stilbenedicarboxylic acid or derivatives thereof (A), as examples of derivatives of 4,4′-stilbenedicarboxylic include derivatives obtained by substituting OH groups at both ends of the dicarboxylic acid with substituents such as chloride and amide.

As the alcohol component (B), for example, dihydric alcohols such as ethylene glycol, propylene glycol, diethylene glycol, neopentyl glycol, 1,4-butanediol, 1,6-hexane diol, 1,6-cyclohexane dimethanol, and other; trivalent or higher alcohols such as glycerin, trimethylolpropane and pentaerythritol, and other; an alcohols having an iso-cyanurate ring; and the like may be included. As examples of this alcohols having the isocyanurate ring, tris(hydroxymethyl)isocyanurate, tris (2-hydroxyethyl) isocyanurate (THEIC), tris (3-hydroxypropyl) isocyanurate, and the like may be included.

When ethylene glycol (OH—CH₂—CH₂—OH), for example, is used as the alcohol component (B), by reacting with 4,4′-stilbenedicarboxylic acid or a derivative thereof (A), ester bond such as the formula (III) is formed.

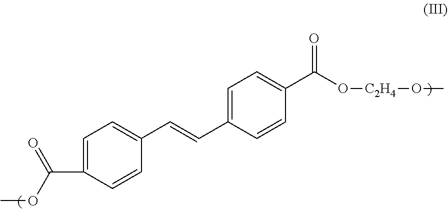

(R₁ in above-mentioned general formula (I) is CH₂—CH₂ of an alcohol residue derived from ethylene glycol (OH—CH₂—CH₂—OH)

As the acid component (C), for example, aromatic tetracarboxylic acid may be used.

As the aromatic tetracarboxylic acid, for example, an aromatic tetracarboxylic acid selected from the group consisting of the following structural formulas (IV) to (XII) is preferable.

Preferable examples of the aromatic tetracarboxylic acid include pyromellitic anhydride (PMDA), benzophenonetetracarboxylic dianhydride (BTDA), 4,4′-oxydiphthalic anhydride (ODPA), 3,3′ 4,4′-diphenylsulfone tetracarboxylic dianhydride (DSDA), bis (3-amino-4-methylphenyl) hexafluoropropane (BAPS).

As the aromatic tetracarboxylic acid, it is preferable to use an anhydride.

The aromatic tetracarboxylic acid may have a substituent. Two or more of these aromatic tetracarboxylic acids may be used.

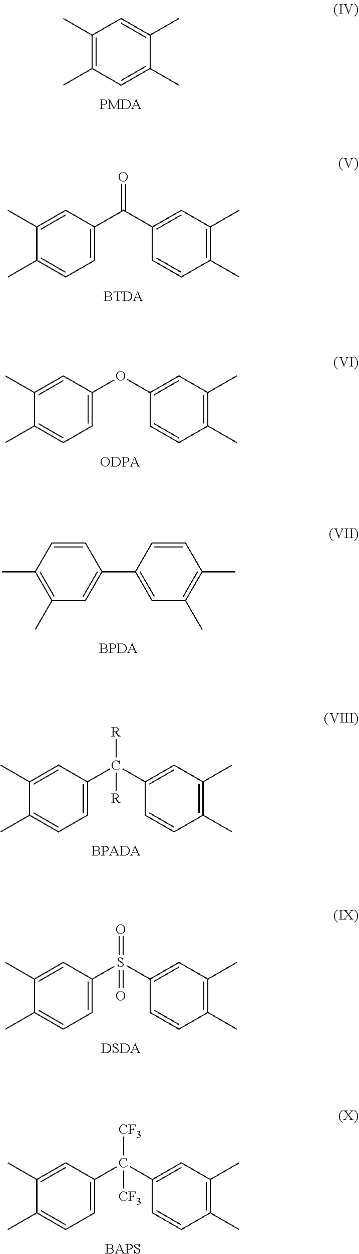

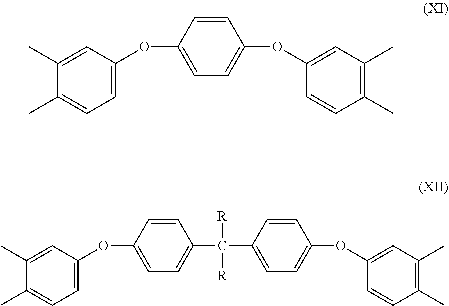

(R in the above structural formulas (VIII) and (XII) represents a hydrocarbon group.)

The diamine component (D) which is reacted with the acid component (C) to generate imide bonds is not particularly limited, but aromatic diamine is preferably used. As the aromatic diamine, for example, 4,4′-diaminodiphenylmethane, 4,4′-diaminodiphenyl ether, p-phenylenediamine, m-phenylenediamine, 1,4-diaminonaphthalene, hexamethylenediamine, diaminodiphenylsulfone, etc. can be used.

Polyesterimide is obtained by reacting 4,4′-stilbenedicarboxylic acid or a derivative thereof (A) and the alcohol component (B) with imide acid obtained by reacting the diamine component (D) and the acid component (C) and reacting them.

The obtained polyesterimide has, for example, a repeating unit of an ester bond of a 4,4′-stilbenedicarbonate group as shown in the following general formula (A), and an imide bond of an aromatic tetracarboxylic acid of repeating units.

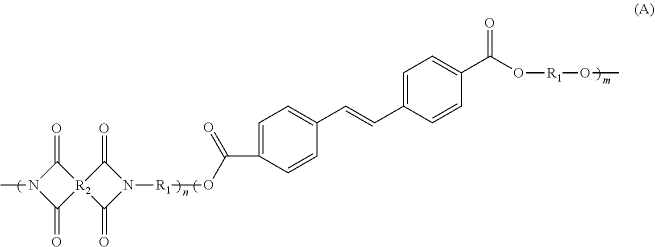

The repeating unit m of the ester bond of the 4,4′-stilbenedicarbonate group by the reaction of the 4,4′-stilbenedicarboxylic acid or a derivative thereof (A) and the alcohol component (B) in the general formula (A) is preferably 10-90 mol %. The repeating unit n of the imide bond of the aromatic tetracarboxylic acid is preferably 90-10 mol %. Deviating from these ranges, it becomes impossible to satisfy balanced requirements such as heat conductivity, heat resistance (heat softening temperature), heat shock resistance and the like.

The polyesterimide may be prepared by reacting the aromatic tetracarboxylic acid with the diisocyanate component (E) to introduce the amide group into the imido group-containing aromatic tetracarboxylic acid.

Examples of the diisocyanate component (E) include diphenylmethane diisocyanate (MDI), diphenyl ether-4,4′-diisocyanate, 4,4′-diisocyanato-3,3′-dimethyl biphenyl (TODI), diisocyanatonaphthalene (NDI), metaxylene diisocyanate (XDI), and toluene diisocyanate (TDI).

As described above, R in the above structural formulas (VIII) and (XII) represents a hydrocarbon group, examples of the hydrocarbon group include an alkyl groups such as an ethyl group, and a methyl group; an aryl group such as a vinyl group, a phenyl group, a naphthyl group, and the like.

The polyesterimide resin insulating coating material can be obtained by dissolving the polyesterimide resin represented by the general formula (A) of the present invention as a main component in a solvent component.

The solvent component is not particularly limited, and examples thereof include organic solvents such as N-methylpyrrolidone, dimethylformamide, dimethylacetamide, xylene, solvent naphtha and the like. Preferably, the use of N-methyl-2-pyrrolidone (NMP) is preferred from the solubility of the resin and the like.

Various additives can be added to the electrically insulating coating.

Such additives include crosslinking agents, lubricants and the like. Examples of the crosslinking agent include a Ti catalyst and the like. Examples of the lubricant include fatty acid esters, low molecular weight polyethylene, wax and the like.

As such additives, coloring agents and antioxidants (weather resistant agents) such as phenol type antioxidants, flame retardants, reaction catalysts and the like may be added, if necessary.

In the case of using the polyesterimide resin to constitute an electrically insulating coating material, it is preferable to set the polyesterimide resin to 50% or less of the total from the viewpoints of solubility with a solvent component, thermal conductivity, electric wire physical properties, and the like preferable.

In the case of obtaining a polyesterimide resin insulating coating material using the polyesterimide resin represented by the general formula (A) of the present invention as a main component, it is preferred that the polyesterimide resin be in the form of a powder of an appropriate particle, from the viewpoints of solubility, thermal conductivity and electric wire physical properties.

The polyesterimide resin, the thermal conductivity can be further improved by adding a ceramic powder to the powdery polyesterimide resin.

The ceramics is defined as “nonmetal ⋅ inorganic material, which has undergone high temperature treatment in its manufacturing process”.

Among the ceramics, it include also the fine ceramics, and in Japanese Industrial Standards (JIS) 1600 (the fine ceramics related term), Fine Ceramics is defined such as follow.

“Fine Ceramics are ceramics which produced with precisely controlled chemical, compositions, microstructures, configurations and production processes to fulfill intended functions, and which are composed mainly of non-metallic, inorganic substances.”

From the viewpoint of composition, the ceramics can be classified as follows.
Element system: for example, diamond (C)
Oxide system: for example, alumina (Al₂O₃), zirconia
Hydroxide system: for example, hydroxyapatite
Carbides system: for example, silicon carbide (SiC)
Nitride system: for example, silicon nitride
Halide system: for example, fluorite
Besides, carbonates system, phosphates system
Major fine ceramics include barium titanate, ferrite, lead zirconate titanate, silicon carbide, silicon nitride, steatite (MgOSiO₂), zinc oxide, zirconia, and the like.

In the present invention, when the ceramics powder is used, thermal conductivity can be further improved by adding boron nitride, silicone carbide, aluminum nitride, or aluminum oxide to the ceramic powder.

In the present invention, the proportion of the aromatic carboxylic acid such as PMDA and 4,4′-stilbenedicarbonate in the blending composition affectes the solubility of the resin, the thermal conductivity of the electrically insulating material, the performance of the coating film and the electric wire characteristics.

The proportion of the 4,4′-stilbenedicarbonate in the compounding composition is preferably 0.2 to 0.35.

The proportion of the aromatic carboxylic acid in the compounding composition is preferably 0.15-0.3.

In the present invention, a suitable solid content in the case of obtaining a polyesterimide resin insulating coating material by dissolving the polyesterimide resin represented by the general formula (A) as a main component is not particularly limited as long as it satisfies the solubility of the resin, considering thermal conductivity and electric wire characteristics, it is preferably 20-30% (by weight).

In the present invention, the electrically insulated electric wire can be constituted by coating and baking the above electrically insulating coating compound on a conductor.

The electrically insulated electric wire (magnet wire) can be constituted, by coating of the electrically insulating coating compound to the conductor (conductive wire) such as a copper, and by baking in a baking oven.

### EXAMPLES

Hereinafter, examples will be described for providing a more detailed understanding of the present invention. Needless to say, the present invention is not limited to only the following examples.

### Example 1

In molar ratio,
4,4′-stilbene dicarboxylic acid amide (StDA) 0.28
Ethylene glycol 2.52
Tris (2-hydroxyethyl) isocyanurate 2.80
Trimellitic anhydride 2.80
4,4′-diaminodiphenylmethane 1.39
and
Dimethyl terephthalate 2.52
   are used.

Each material was dissolved in a solvent at a blending concentration of 25% and heated to produce the polyesterimide resin coating material. The resin content concentration was 44%.

The electric insulating wire made by using the polyesterimide resins coating compound obtained from the above examples.

Structure and specification of electric insulating wires:
(I) Baking furnace (used a horizontal electric heat furnace)
(II) The drawing method:
dice, and the number of times to drawing: 6 times
(1.05, 1.07, 1.09, 1.11, 1.13, 1.14)
(III) Baking temperature (degrees C.):
temperature (degrees C.) of a furnace: Bottom 370° C.-Medium 450° C.-Upper 500° C., annealing temperature 550 to 580 degrees C.
(IV) Linear velocity: 20 m·min.
(V) Conducting wire radial: 1.000 mm
(VI) Wire radial: 1.089-1.090-1.092 mm
(VII) Coating thickness: 0.45 mm

The recognition of characteristic of the electric insulating wire was carried by the following recognition method of characteristic of the electric insulating wire.

Recognition of characteristic of the electric insulating wire:

Recognition of characteristic of the electric insulating wire was carried by the following method of the recognition of characteristic of the electric insulating wire

(a) Breakdown voltage;

Insulating breakdown voltage (kV) was measured based on Japanese Industrial Standards (JIS) C 3216-4.

(b) Heat softening resistance;

It was measured at load 500 g. The average number (degrees C.) calculates.

(c) Heat shock by NEMA method;

The number of cracks after heat treatment at 220 degrees C. and 0.5 hour was measured by NEMA method.

(d) One way ear test:

A one way ear test was carried out using a scraper tester (electric wire abrasion tester for automobiles), and abrasion resistance was evaluated by the wear resistance test method of JIS C 3003-1984.

### (e) Thermal Shock Resistance (Sudden Jack=Rapid Extension):

In accordance with the heat shock test method prescribed in the NEMA standard MW-1000 in the United States of America, thermal shock resistance at 20% SJ (Suddenjak=rapid extension) was evaluated.

(f) Glass transition temperature (Tg);

Tg (tan δ) (degrees C.) was measured based on the heater method and the metal bath method. The results are shown in Table 1.

(G) Measurement of thermal conductivity:

Evaluation of thermal conductivity performance can be made by measuring thermal conductivity. The thermal conductivity is a physical quantity defining the magnitude of the heat flux carried along the gradient in the case where there is a temperature gradient in the medium in thermal conduction and is also called heat conduction.

Assuming that the heat flux is J, the temperature is T, and the temperature gradient is grad T, the thermal conductivity λ is defined as the proportional coefficient of Fourier's law: J=−λgrad T. SI unit is watt per meter per Kelvin W/(m·K). As a symbol of thermal conductivity, k is used in addition to λ.

K value (W/(m·K)) was measured according to ASTM D5470-06.

The k value (W/(m·K)) of the polyesterimide coating compound obtained as described above was 0.28 W/(m·K).

The k value of the polyesterimide resin having the repeating unit of the 4,4′-stilbenedicarbonate group of the present invention is in the range of 0.25-0.3 W/(m·K), on the other hand, the usual polyesterimide resin does not exceed 0.25 W/(m·K), hence, the polyesterimide resin of the present invention is evaluated that it has excellent thermal conductivity.

### COMPARATIVE EXAMPLE

### Comparative Example 1

In the same manner as in Example 1 except that 4,4′-stilbene dicarboxylic acid amide (StDA) was not used,
with the same number of moles of the following compounding ingredients,
Ethylene glycol
Tris (2-hydroxyethyl) isocyanurate
Trimellitic anhydride
4,4′-diaminodiphenylmethane
and
Dimethyl terephthalate
   are used, the polyesterimide resin coating material was produced in the same manner.

Using the obtained polyesterimide resin coating material, an electrically insulated electric wire was formed as shown in Table 1, and electric wire characteristics were evaluated in the same manner as in Example 1.

The k value of the polyesterimide resin coating material was measured in the same manner as in Example 1, and the k value was 0.20 W/(m·K).

TABLE 1

| | Unit | | | | | | |
|---|---|---|---|---|---|---|---|
| | Method | | | | Comparable | | |
| Test items | etc | Example 1 | | | Example 1 | | |
| Baking furnace | | Vertical electric heat furnace | | | | | |
| Drawing method | | Dice | | | | | |
| Baking temp. | | bottom 370 dgree C. | | | | | |
| | | medium 450 dgree C. | | | | | |
| | | top 500 dgree C. | | | | | |
| | | annealing: 550-580 degree C. | | | | | |
| Linear velocity | m/min | 20 | | | 20 | | |
| Appearance | | good | | | good | | |
| Conducting wire | mm | 1.000 | | | 1.000 | | |
| radial | | | | | | | |
| Wire radial | mm | 1.089 | 1.090 | 1.092 | 1.083 | 1.083 | 1.086 |

| Coating thickness | mm | 0.045 | | 0.042 | |
|---|---|---|---|---|---|
| Breakdown | kv | 10.19 | | 13.36 | |
| voltage | | | | | |
| Heat softening | average | 428 | | 432 | |
| resistance | dgree C. | | | | |
| load 700 g | | | | | |
| NEMA Heat shock | 1 d | 5 | 5 | 1 | 2 |
| 220 dgree C. | 2 d | 3 | 4 | 0 | 0 |
| 0.5 hour | 3 d | 3 | 4 | 0 | 0 |
| Cracks number | 4 d | 0 | 2 | 0 | 0 |
| | average | 16.9 | | 33.8 | |
| One way ear test | max. | 19.6 | | 34.5 | |
| load 160 g | mini. | 15.8 | | 21.0 | |
| Thermal Shock | float | 0.5 | 0.5 | 0.3 | 0.5 |
| Resistance | (mm) | | | | |
| Sudden Jack | exposure | 1.8 | 2.0 | l.4 | 1.6 |

| | | | |
|---|---|---|---|
| | (mm) | | |
| Glass transition | Heater | 230 | 203 |
| temp. | method | | |
| Tandelta tan δ | Metal | 190 | 190 |
| Tg degree C. | method | | |

### INDUSTRIAL APPLICABILITY

The present invention can be applied to electric insulating coating compound and electric insulating wire, additionally, the present invention can be applied to various electrical insulating materials such as an adhesive etc. requiring electrical insulation performance.

1. An electric insulating material including a polyesterimide resin having a repeating unit of 4,4′-Stilbenedicarbonate group.

2. The electric insulating material according to claim 1, wherein the polyesterimide resin is a polyesterimide resin having a repeating unit of 4,4′-stilbenedicarbonate expressed by a following general formula (I), and having a repeating unit of an imide bond of a tetracarboxylic acid expressed by a following general formula (II) 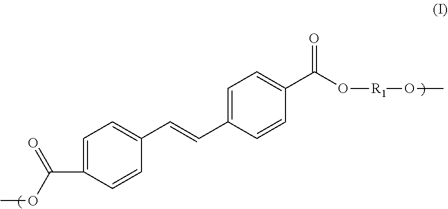
wherein R₁ is an alcohol residue: 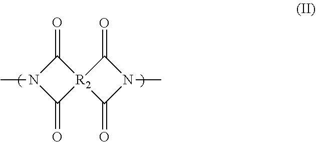
wherein R₂ is a tetracarboxylic acid residue.

3. The electric insulating material according to claim 1, further comprising the polyesterimide resin added a ceramic powder.

4-6. (canceled)

7. The electric insulating material according to claim 2, further comprising the polyesterimide resin added a ceramic powder.

8. The electric insulating material according to claim 3, wherein the ceramic powder is selected from the group consisting of boron nitride, silicon carbide, aluminum nitride and aluminum oxide.

9. The electric insulating material according to claim 7, wherein the ceramic powder is selected from the group consisting of boron nitride, silicon carbide, aluminum nitride and aluminum oxide.

10. An electric insulating coating compound including the electric insulating material of claim 1.

11. An electric insulating coating compound including the electric insulating material of claim 2.

12. An electric insulating coating compound including the electric insulating material of claim 3.

13. An electric insulating coating compound including the electric insulating material of claim 7.

14. An electric insulating wire comprising the electric insulating coating compound of claim 10 and a conductor, wherein the electric insulating wire is made by coating and baking of said electric insulating coating compound on the conductor.

15. An electric insulating wire comprising the electric insulating coating compound of claim 11 and a conductor, wherein the electric insulating wire is made by coating and baking of said electric insulating coating compound on the conductor.

16. An electric insulating wire comprising the electric insulating coating compound of claim 12 and a conductor, wherein the electric insulating wire is made by coating and baking of said electric insulating coating compound on the conductor.

17. An electric insulating wire comprising the electric insulating coating compound of claim 13 and a conductor, wherein the electric insulating wire is made by coating and baking of said electric insulating coating compound on the conductor.
